(19) United States
(12) Patent Application Publication
(10) Pub. No.: US 2010/0123331 A1
(43) Pub. Date: May 20, 2010

(54) TRUCK BED TARP SYSTEM

(75) Inventors: Terrence J. Buelna, Santa Barbara, CA (US); Tim Selby, Templeton, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Terrence J. Buelna, Santa Barbara, CA (US)

(21) Appl. No.: 12/271,678

(22) Filed: Nov. 14, 2008

(51) Int. Cl. B60P 7/04

(52) U.S. Cl. 296/100.15

(57) ABSTRACT

Systems and methods are provided for attaching a tarpaulin to a truck bed. The tarpaulin is placed over a top opening of the truck bed. A plurality of fastening elements are attached to the tarpaulin. A plurality of tie down members are attached to the sides of the truck bed. A first end of a flexible cord is coupled to a first tie down member. A ratchet is coupled with the first tie down member. The flexible cord is intermittently coupled with the attached plurality of fastening elements and the attached plurality of tie down members. A second end of the flexible cord is passed through the ratchet and tension is applied to the flexible cord to secure the flexible cover to the open enclosure. The ratchet holds the flexible cord in position to maintain the applied tension.

### BACKGROUND OF THE INVENTION

The invention generally relates to securing a cover onto an open container, and more particularly relates to securing a tarp or tarpaulin onto a truck bed.

Pick up trucks generally have an open truck bed. These truck beds do not have height restrictions which limit that transportation of large objects. But, a disadvantage of an open truck bed is that the contents or cargo of the truck bed are exposed to environmental elements such as sun, sleet, snow, rain, wind and pollution. Thus, systems using tarpaulins have been used to cover and restrain truck bed cargo.

Cargo restraining systems generally consist of a tarpaulin and a rope, bungee cords or tensioning straps. The tarpaulin may contain eyelets around the periphery to where the ropes or cords are attached and secured to the truck bed by anchor points. These anchor points are usually mounted onto the sides of the truck bed and may permanently damage the truck bed. Bungee cords are usually secured only via their hooks. Therefore, improved systems and methods of restraining cargo using a tarpaulin, which are more secure and less damaging to the truck bed, are desired.

Patents and publications of interest include U.S. Pat. No. 7,219,944 to Klotz et al., U.S. Pat. No. 5,806,816 to Hull et al., U.S. Pat. No. 5,066,063 to Mullally, U.S. Pat. No. 4,281,872 to Biancale, U.S. Pat. No. 4,014,590 to Schulz, Jr., U.S. Pat. No. 3,797,859 to Vasques, U.S. Pat. No. 2,967,733 to Amerine, and U.S. Pat. No. 2,889,171 to Morris as well as French Patent No. 2658456 to Gerard.

### BRIEF SUMMARY OF THE INVENTION

Embodiments of the invention provide systems and methods for attaching a flexible cover to an open enclosure. The flexible cover may comprise a tarpaulin and the open enclosure may be a truck bed. The flexible cover is placed over an opening of the open enclosure. A plurality of fastening elements are present in or attached to the flexible cover, for example, to the edges of the flexible cover. A plurality of tie down members are attached to the sides of the open enclosure. A first end of a flexible cord is coupled to a first tie down member. A ratchet is coupled with the first tie down member. The flexible cord is intermittently coupled between at least some of the plurality of fastening elements on the flexible cover and the plurality of tie down members on the open enclosure. A second end of the flexible cord is passed through the ratchet and tension is applied to the flexible cord to secure the flexible cover to the open enclosure, for example, by pulling on the second end of the flexible cord. The ratchet holds the flexible cord in position to maintain the applied tension, thus maintaining the flexible cover secured onto the open enclosure. Alternatively, any tensioning means such as buckles, tensioning straps, or knots may be used in place of the ratchet. Also, the open enclosure may be provided with tie down hooks or anchors, and the flexible cord may be coupled between the plurality of fastening elements on the flexible cover and the tie down hooks or anchors of the open enclosure.

In some cases, the flexible cord may be passed through a plurality of eyelets of at least one side of the flexible cover, thereby coupling the flexible cord to the flexible cover.

Each of the fastening elements may comprise a clip for attaching the fastening elements to an edge of the flexible cover. They may also comprise a hook having one end for capturing the flexible cord. Furthermore, each fastening element may be padded, for example, with a soft foam outer covering, so that they do not scratch or otherwise damage the sides of the open enclosure or truck bed.

Each tie down member may comprise a suction cup and the plurality of tie down members may be attached to the sides of the open enclosure by applying suction. Each tie down member may comprise a tie down ring which can capture a ratchet hook of the ratchet to couple each tie down member with the ratchet. The tie down ring of a first tie down member may be used to capture a first end hook of the first end of the flexible cord to couple the first tie down member with the first end of the flexible cord.

A plurality of hooks may be provided. These hooks may be S-shaped and be used to couple the flexible cord with the attached plurality of tie down members.

The ratchet may comprise a ratchet hook which may be captured by a tie down slot of the first tide down member to couple the ratchet with the first tie down member.

### BRIEF DESCRIPTION OF THE DRAWINGS

FIG. 1 shows a system for securing a flexible cover over an open enclosure according to embodiments of the invention;

FIGS. 2-2C1 show views of a tie down member of the system of FIG. 1;

FIGS. 3A and 3B show views of a fastening element of the system of FIG. 1;

FIGS. 4A-4J show a method of using the system of FIG. 1 to secure a flexible cover over an open enclosure; and

FIG. 5 shows a flow chart depicting a method of securing a flexible cover over an open enclosure according to embodiments of the invention.

### DETAILED DESCRIPTION OF THE INVENTION

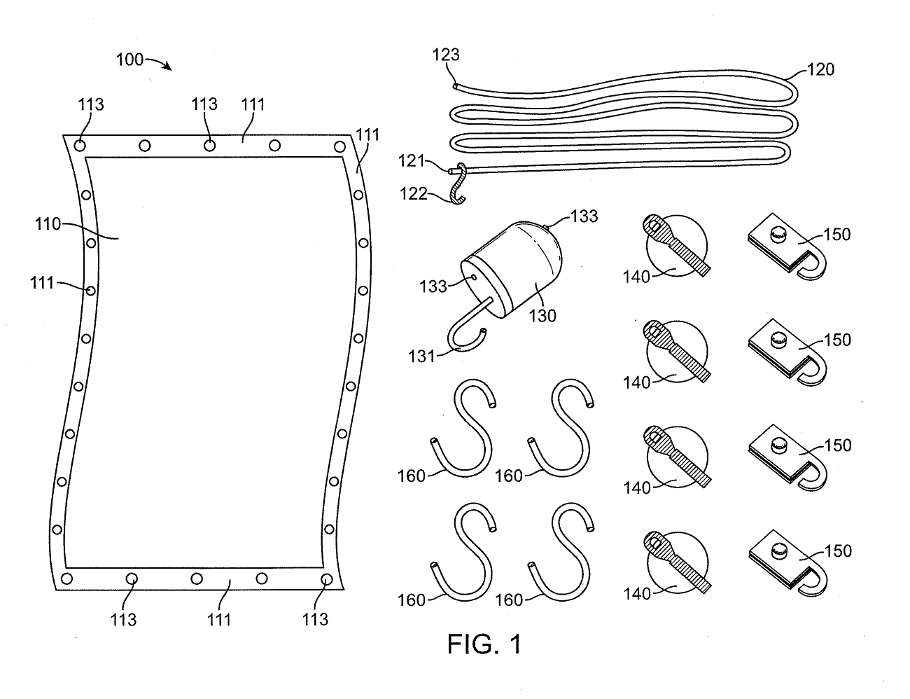

FIG. 1 shows a system 100 for securing a tarpaulin 110 or any type of flexible cover over a truck bed or any type of open enclosure according to embodiments of the invention. Tarpaulin 110 may be included with system 100 or may be an off-the-shelf component. System 100 may comprise a flexible cord 120, a ratchet 130, a plurality of tie down members 140, a plurality of fastening elements 150, and a plurality of hooks 160. Tarpaulin or tarpaulin 110 may have a plurality of eyelets 113 along its periphery, i.e., along one or more of its edges 111. Flexible cord 120 has a fixed first end 121 and a free second end 123. Flexible cord 120 may comprise, for example, a bungee cord. Typically, a fixed first end hook 122 will be tied or otherwise coupled to the fixed first end 121 of flexible cord 120. Ratchet 130 comprises a ratchet hook 131 and a ratchet slot 133. Flexible cord 120 can be threaded through ratchet slot 133 to secure it thereto. As shown, hooks 160 are S-shaped and can be referred to as S-hooks 160. However, hooks 160 may have any number of shapes, for example, they may be G-shaped or C-shaped.

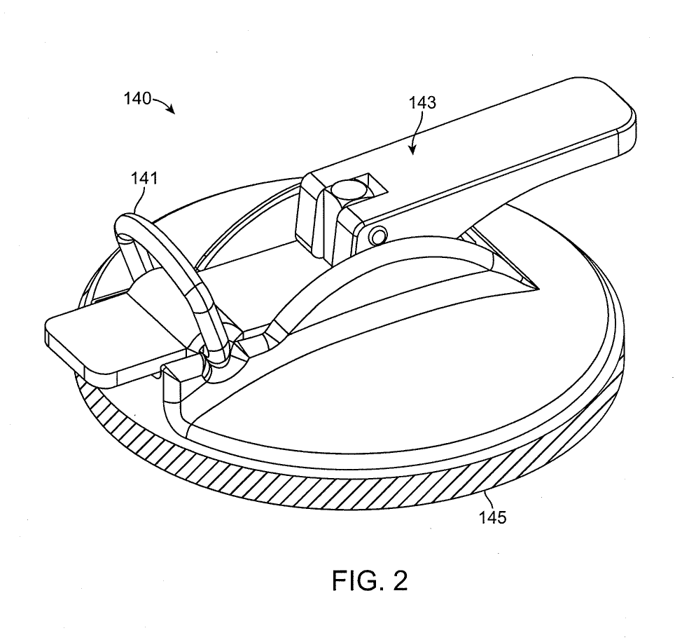

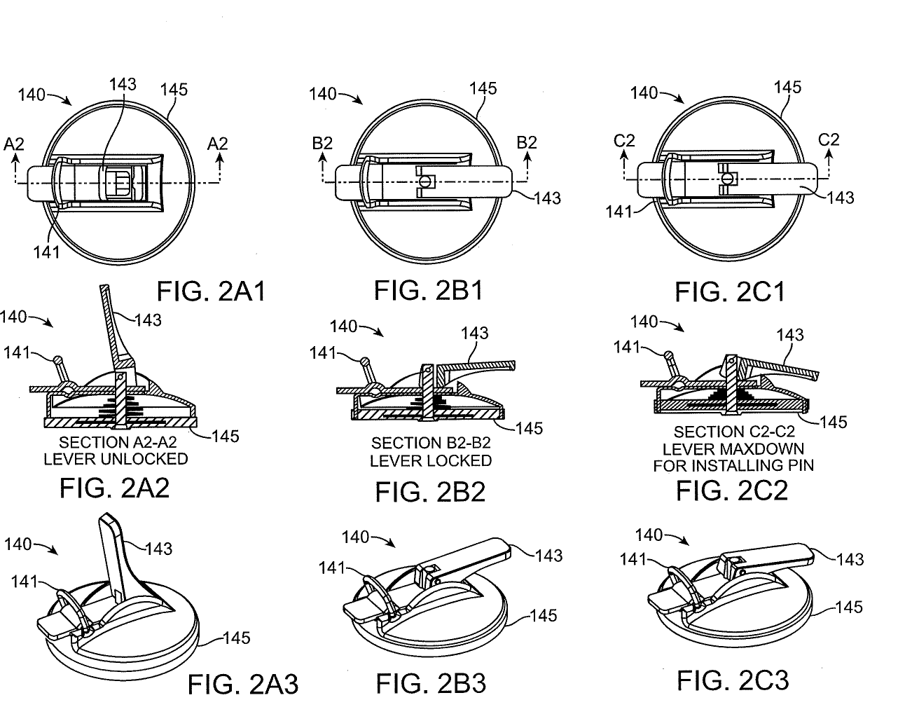

FIGS. 2-2C3 show a tie down member 140. FIG. 2 shows a perspective view of tie down member 140. As shown, tie down member 140 is a lever-activated suction cup. Tie down member 140 comprises a tie down ring 141, a suction cup actuation lever 143, and a suction cup 145. FIGS. 2A1, 2A2 and 2A3 respectively show a top view, a side cross-sectional view, and a perspective view of an unlocked tie down member 140. As suction cup actuation lever 143 is pressed down and locked such that it is parallel with the main body of tie down member 140, the internal volume of suction cup 145 is raised. Thus, when tie down member is placed over a surface, pressing lever 143 down applies a suction to attach tie down member 140 to the surface. FIGS. 2B1, 2B2 and 2B3 respectively show a top view, a side cross-sectional view, and a perspective view of a locked tie down member 140. Lever 143 may be pressed down to a maximum level as shown by FIGS. 2C1-2C2, which respectively show a top view, a side cross-sectional view, and a perspective view of a maximally locked tie down member 140.

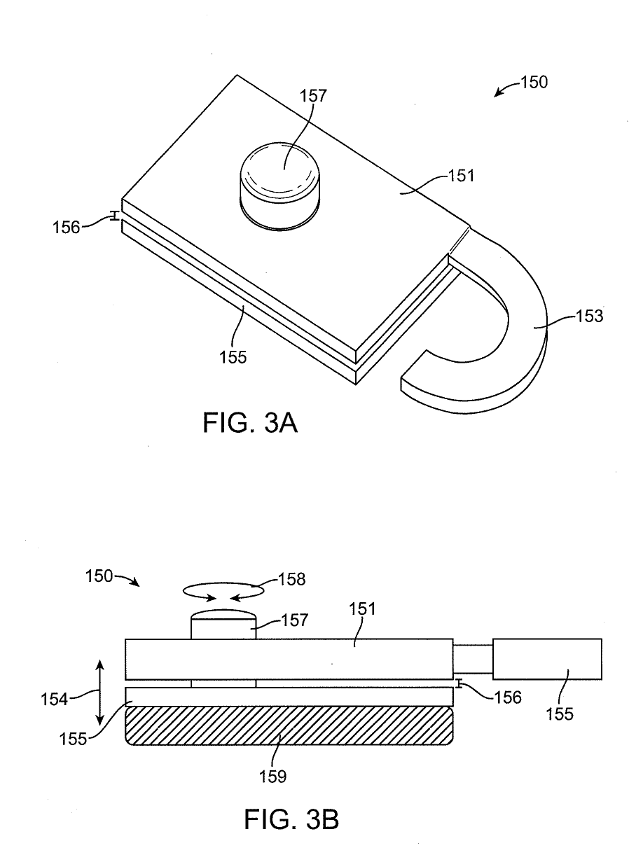

FIGS. 3A and 3B respectively show a perspective view and a side view of fastening element 150. Fastening element 150 comprises a main body 151, a secondary body 155, and a rotatable knob 157. Main body 151 comprises a hook 153. Secondary body 155 may comprise a soft, foam pad 159. Rotation of rotatable knob 157, as indicated by arrow 158, adjusts the distance 156 between main body 151 and secondary body 155 by adjusting the position of main body 151 and secondary body 155 relative to one another in the direction indicated by arrow 154. When an edge 111 of the tarpaulin 110 is placed in between main body 151 and secondary body 155, rotatable knob 157 can be rotated to tighten and secure main body 151 and secondary body 155 onto edge 113. Also, the point of attachment between fastening element 150 and tarpaulin 110 may be anywhere on the tarpaulin 500, including its sides, edges, corners, folds made on the body of the tarpaulin 110, etc. Tarpaulin 110 may be a tarpaulin of any size.

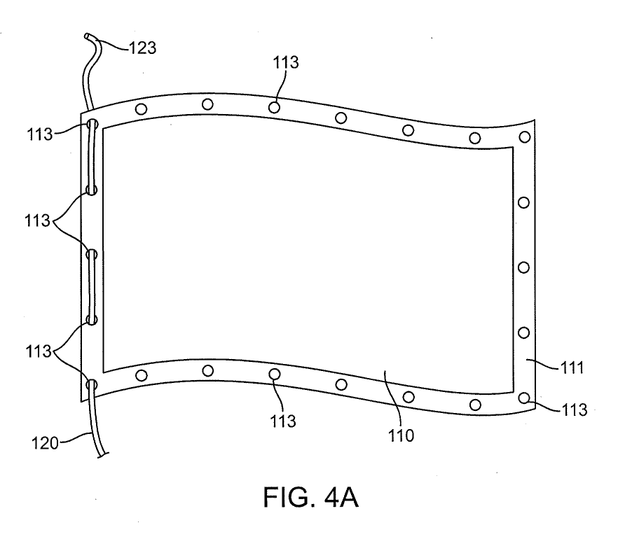

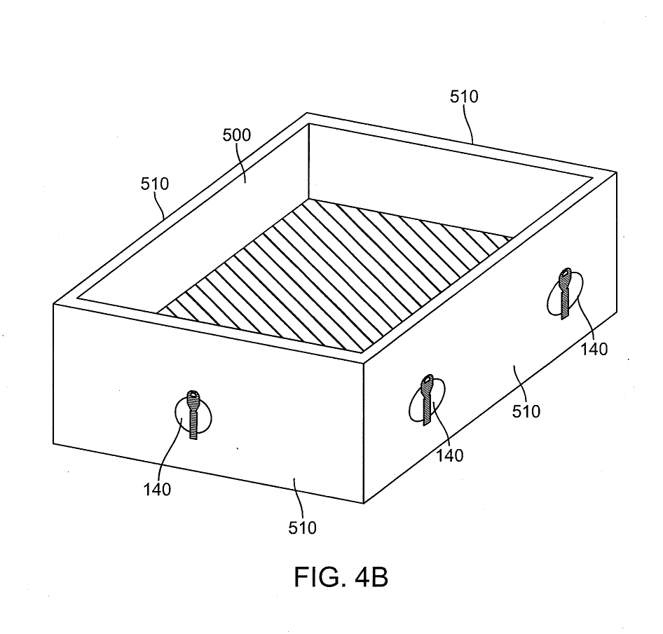

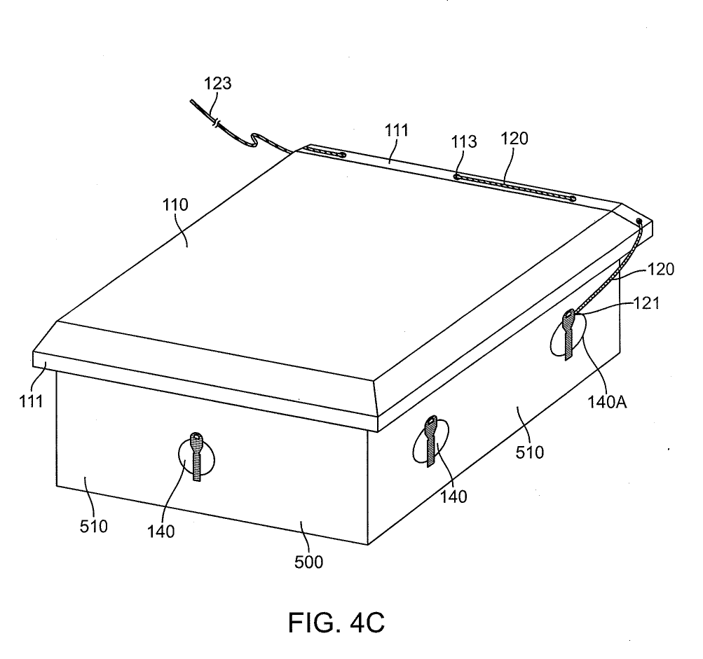

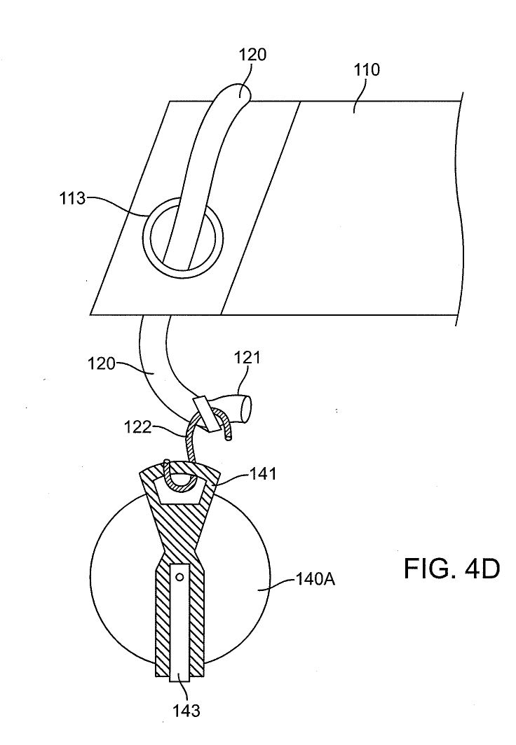

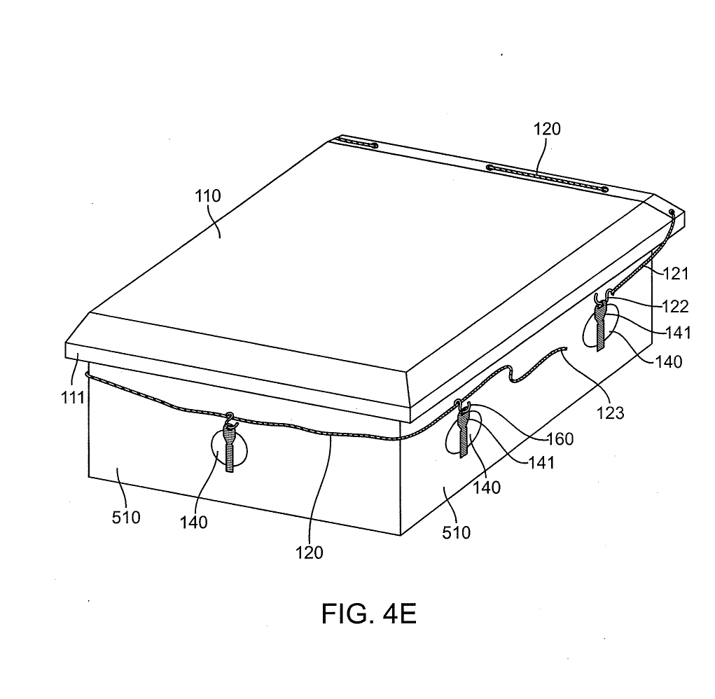

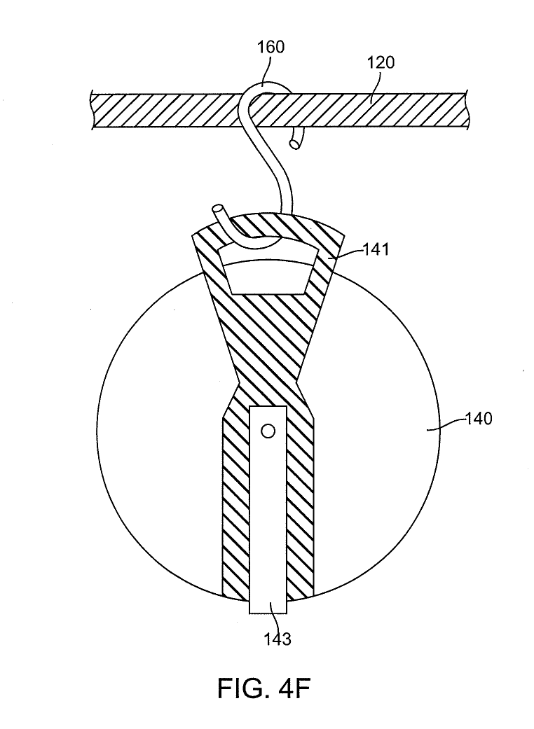

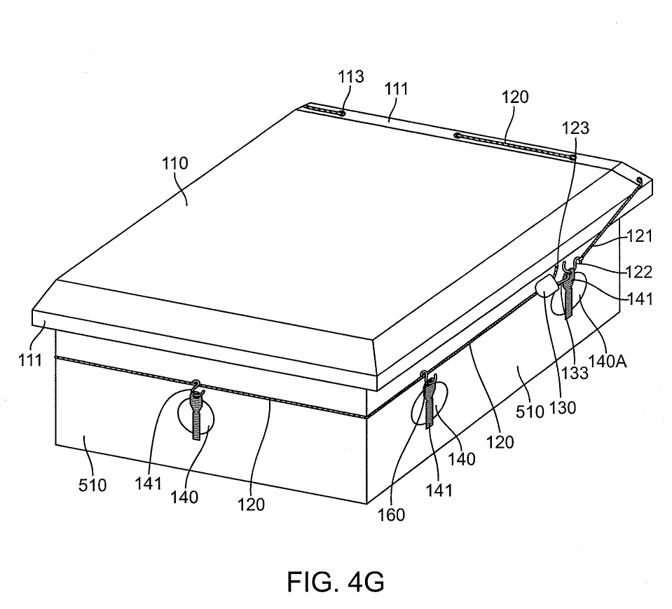

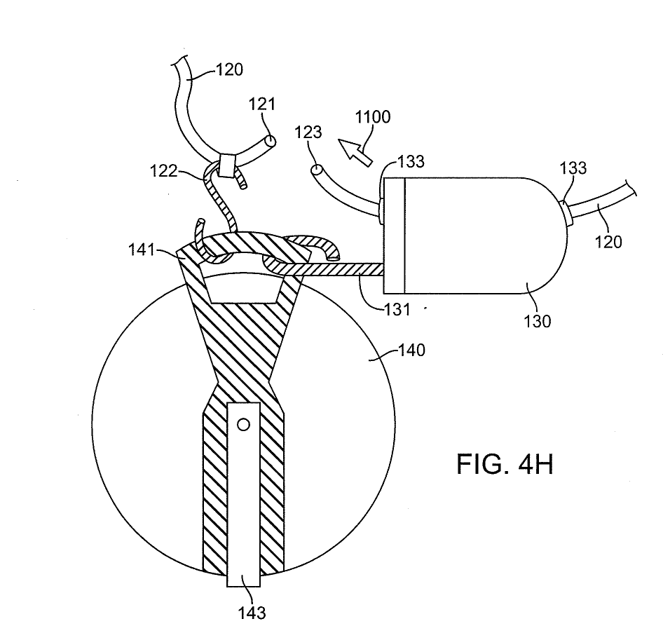

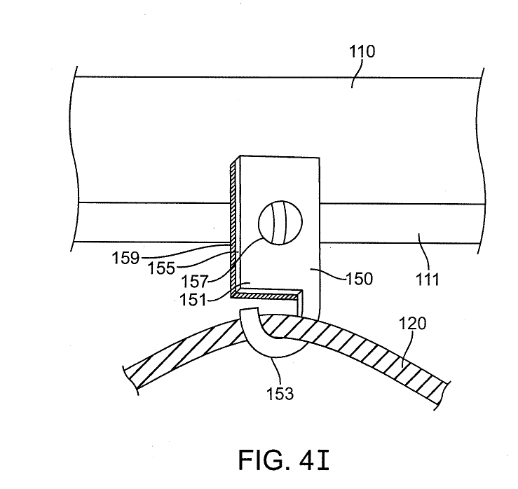

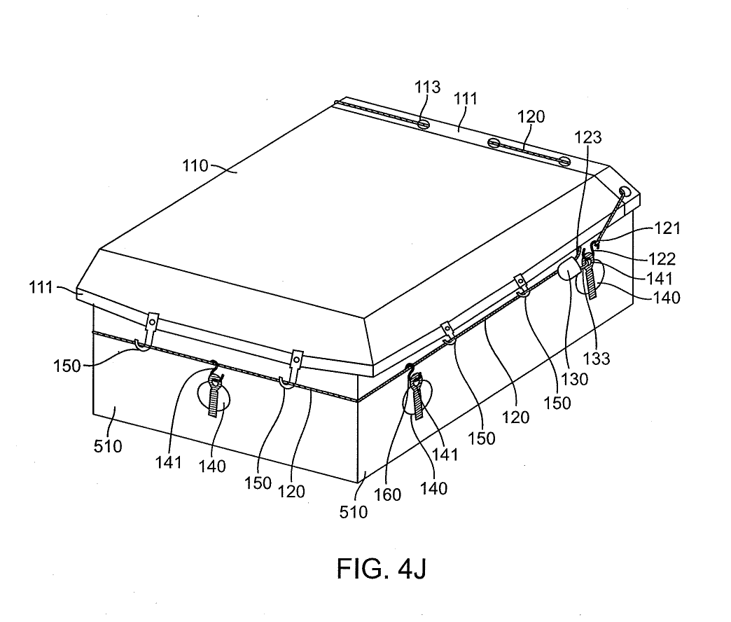

FIGS. 4A-4J show a method of using system 100 to secure a flexible cover or tarpaulin 110 to an open enclosure, for example, a truck bed 500, according to embodiments of the invention. As shown by FIG. 4A, leading with free second end 123, flexible cord 120 is threaded through eyelets 113 present on an edge 111 of tarpaulin 110. As shown by FIG. 4B, tie down members 140 are secured onto sides 510 of truck bed 500, for example, via suction. Tie down members 140 and/or sides 510 of truck bed may be wiped clean of dirt and other material before securing tie down members 140 onto sides 510 so as to improve suction. Next, as shown by FIG. 4C, tarpaulin 110 is laid over truck bed 500 thereby covering its top opening. Fixed first end 121 of flexible cord 120 is coupled to a first tie down member 140A. FIG. 4D shows a zoomed-in view of this coupling. Fixed first end hook 122 of fixed first end 121 is hooked through tie down ring 141 of first tie down member 140. Alternatively, truck bed 500 may itself include tie down hooks or anchors and tie down members 140 may not need to be provided. As such, fixed first end 121 of flexible cord 120 can be coupled to a first tie down hook or anchor of the truck bed 500. Next, as shown by FIG. 4E, the remainder of flexible cord 120, led by free second end 123, is wrapped around sides 510 of truck bed 500. The remaining individual tie down members 140 already secured to sides 510 are coupled to flexible cord 120 via S-hooks 160 as shown by FIG. 4F. One end of S-hook 160 hooks onto flexible cord 120 while the other hooks through tie down ring 141. Afterwards, as shown by FIG. 4G, ratchet 130 is coupled to first tie down member 140A and free second end 123 of flexible cord 120 is coupled to ratchet 130. FIG. 4H shows a zoomed-in view of first tie down member 140A, free second end of flexible cord 120, and ratchet 130 coupled together. Both ratchet hook 131 and fixed first end hook 122 are hooked through tie down ring 141. Free second end 123 of flexible cord 120 is threaded through ratchet slot 133. Ratchet 130 may be configured to allow flexible cord 120 to only be pulled through ratchet slot 133 in the direction of arrow 110. Thus, pulling flexible cord 120 through ratchet slot 133 applies tension to the remainder of flexible 120 which is wrapped around truck bed 500, thus tightening flexible cord 120 around truck bed 120. By allowing movement of flexible cord 120 in only one direction, ratchet 130 can maintain this tension. Other means of tensioning flexible cord 120, for example, tensioning straps or knots, may also be used. As shown by FIG. 4I, fastening elements 150 are then secured onto the periphery or edges 111 of tarpaulin 110 as previously described. Fastening elements 150 are positioned intermittently between tie down members 140 (or, in the case where tie down hooks or anchors are included in the truck bed, the tie down hooks or anchors of the truck bed). Foam pads 159 prevent fastening elements 150 from scratching, impacting, or otherwise damaging the surface of sides 510 of truck bed 500. Hook 153 of individual fastening elements are hooked over flexible cord 120 pull flexible cord 120 and periphery or edges 111 together, further applying tension to the flexible cord 120 wrapped around truck bed 500 and securing tarpaulin 110 to truck bed 500. In other embodiments, instead of using ratchet 130, other tensioning means may be used, including buckles, tensioning straps, and knots. FIG. 4H shows the end state of system 100 securing tarpaulin 110 to truck bed 500.

Although only the above exemplary steps are described, it can be appreciated by those of ordinary skill in the art that the above-described steps may be performed in any order, additional related steps may be performed, and some steps may be modified or omitted.

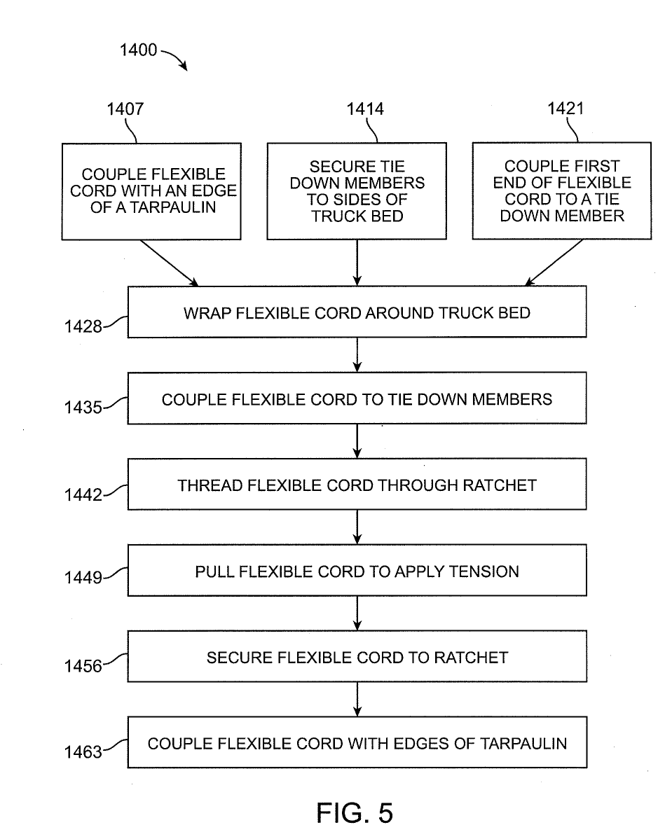

FIG. 5 shows a flow chart depicting an exemplary method 1400 of using system 100 to secure a flexible cover to an open enclosure, for example, tarpaulin 110 to truck bed 500, according to embodiments of the invention. A step 1407 couples a flexible cord with an edge of a tarpaulin, for example, flexible cord 120 with an edge 111 of tarpaulin 110. A step 1414 secures tie down members to sides of a truck bed, for example, tie down members 140 to sides 510 of truck bed 500. A step 1421 couples a fixed first end of a flexible cord to a tie down member, for example, a fixed first end 121 of flexible cord 120 to first tie down member 140A. A step 1428 wraps the flexible cord around the truck bed, for example, flexible cord 120 around sides 510 of truck bed 500. A step 1435 couples the flexible cord to the tie down members, for example, flexible cord 120 to tie down members 140. A step 1442 threads the flexible cord through a ratchet, for example, free second end 123 of flexible cord 120 through ratchet slot 133 of ratchet 130. A step 1449 pulls the flexible cord to apply tension to the portion of the flexible cord wrapped around the truck bed. A step 1456 secures the position of flexible cord with the ratchet. A step 1463 couples the flexible cord with the edges of the tarpaulin, for example, by using S-hooks 160.

Although only the above exemplary steps are described, it can be appreciated by those of ordinary skill in the art that the above-described steps may be performed in any order, additional related steps may be performed, and certain steps may be modified or omitted.

Although certain exemplary embodiments and methods have been described in some detail, for clarity of understanding and by way of example, it will be apparent from the foregoing disclosure to those skilled in the art that variations, modifications, changes, and adaptations of such embodiments and methods may be made without departing from the true spirit and scope of the invention. Therefore, the above description should not be taken as limiting the scope of the invention which is defined by the appended claims.

What is claimed is:

1. A system for securing a flexible cover to an open enclosure, the system comprising:
a plurality of fastening elements removably attached or attachable to the flexible cover;
a plurality of tie down members removably attachable to the sides of the open enclosure;
a flexible cord having a first end and a second end, the first end being removably coupleable to a first tide down member of the plurality of tie down members; and
a ratchet removeably coupleable to the second end of the flexible cord and removably coupleable to the first tie down member,
wherein the flexible cord is adapted to be intermittently coupled to at least one of the plurality of fastening elements and at least one of the remainder of the plurality of tie down members before the second end of the flexible cord is coupled to the ratchet,
wherein pulling the second end of the flexible cord taut applies tension to the flexible cord to secure the flexible cover to the open enclosure, and
wherein the ratchet is adapted to hold the flexible cord in position to maintain the applied tension.

2. The system of claim 1 further comprising the flexible cover.

3. The system of claim 2 wherein the flexible cover comprises a tarpaulin.

4. The system of claim 1 wherein at least one side of the flexible cover comprises a plurality of eyelets, wherein the flexible cord can be passed through the plurality of eyelets to couple the flexible cord to the flexible cover.

5. The system of claim 1 wherein each tie down member comprises a suction cup.

6. The system of claim 1 wherein each fastening element is padded.

7. The system of claim 6 wherein each fastening element comprises a soft foam outer covering.

8. The system of claim 1 wherein each fastening element comprises a hook having one end for coupling the fastening element with the flexible cord.

9. The system of claim 1 wherein each fastening element comprises a clip for removable attaching the fastening element onto the flexible cover.

10. The system of claim 1 further comprising a plurality of hooks for coupling the flexible cord with the plurality of tie down members, wherein each tie down member comprises a tie down slot for capturing a hook.

11. The system of claim 10 wherein the plurality of hooks comprises a plurality of S-shaped hooks.

12. The system of claim 1 wherein the ratchet comprises a ratchet hook and the first tie down member comprises a tie down ring for capturing the ratchet hook to removably couple the first tie down member with the ratchet.

13. The system of claim 1 wherein the first end of the flexible cord comprises a first end hook and the first tie down member comprises a tie down ring for capturing the first end hook to removably couple the first tie down member with the first end of the flexible cord.

14. A method for attaching a flexible cover to an open enclosure, the method comprising:
placing the flexible cover over an opening of the open enclosure;
attaching a plurality of fastening elements to the flexible cover;
attaching a plurality of tie down members to the sides of the open enclosure;
coupling a first end of a flexible cord with a first tie down member of the plurality of tie down members;
coupling a ratchet with the first tie down member;
intermittently coupling the flexible cord with the attached plurality of fastening elements and the attached plurality of tie down members;
passing a second end of the flexible cord through the ratchet; and
applying tension to the coupled flexible cord to secure the flexible cover to the open enclosure,
wherein the ratchet is adapted to hold the flexible cord in position to maintain the applied tension.

15. The method of claim 14 wherein attaching a plurality of fastening elements to the flexible cover comprises attaching a plurality of fastening elements to the edges of the flexible cover.

16. The method of claim 14 further comprising passing the flexible cord through a plurality of eyelets of at least one side of the flexible cover to couple the flexible cord to the flexible cover.

17. The method of claim 14 wherein attaching the plurality of fastening elements to the edges of the flexible cover comprises removably attaching a clip of each fastening element to an edge of the flexible cover.

18. The method of claim 14 wherein each tie down member comprises a suction cup, and wherein attaching the plurality of tie down members to the sides of the open enclosure comprises applying suction to the sides of the open enclosure with each tie down member.

19. The method of claim 14 wherein coupling the ratchet with the first tie down member of the plurality of tie down members comprises capturing a ratchet hook of the ratchet with a tie down ring of the first tie down member.

20. The method of claim 14 wherein coupling the secured flexible cord with the attached plurality of fastening elements comprises capturing the flexible cord with a fastening element hook of each fastening element.

21. The method of claim 14 wherein coupling the secured flexible cord with the attached plurality of tie down members comprises capturing a plurality of hooks with the flexible cord and capturing the plurality of hooks with a tie down ring of each tie down member.

22. The method of claim 21 wherein the plurality of hooks comprises a plurality of S-shaped hooks.

23. A method for attaching a flexible cover to an open enclosure, the method comprising:
placing the flexible cover over an opening of the open enclosure;
attaching a plurality of fastening elements to the flexible cover;
attaching a plurality of tie down members to the sides of the open enclosure;
intermittently coupling a flexible cord with the attached plurality of fastening elements and the attached tie down members;
applying tension to the coupled flexible cord to secure the flexible cover to the open enclosure; and
maintaining the applied tension.

24. The method of claim 23 wherein each tie down member comprises a suction cup, and wherein attaching the plurality of tie down members to the sides of the open enclosure comprises applying suction to the sides of the open enclosure with each tie down member

25. The method of claim 23 wherein the applied tension is maintained using a tensioning strap.

26. The method of claim 23 wherein the applied tension is maintained using a knot.

27. The method of claim 23 wherein the applied tension is maintained using a buckle.

28. A method for attaching a flexible cover to an open enclosure, the open enclosure including a plurality of tie down hooks, the method comprising:
placing the flexible cover over an opening of the open enclosure;
attaching a plurality of fastening elements to the flexible cover;
coupling a first end of a flexible cord with a first tie down hook of the plurality of tie down hooks;
coupling a ratchet with the first tie down hook of the plurality of tie down hooks;
intermittently coupling the flexible cord with the attached plurality of fastening elements and the plurality of tie down hooks of the open enclosure;
passing a second end of the flexible cord through the ratchet; and
applying tension to the coupled flexible cord to secure the flexible cover to the open enclosure,
wherein the ratchet is adapted to hold the flexible cord in position to maintain the applied tension.
